(19) United States
(12) Patent Application Publication
(10) Pub. No.: US 2011/0215252 A1
(43) Pub. Date: Sep. 8, 2011

(54) PHOTON GENERATOR

(76) Inventor: James M. Hume, Elkton, FL (US)

(21) Appl. No.: 12/717,790

(22) Filed: Mar. 4, 2010

(51) Int. Cl. G01J 1/42; G21G 4/00

(52) U.S. Cl. 250/393; 250/493.1

(57) ABSTRACT

A photon generator incorporates a fiber optic element placed in a magnetic field such as that generated by an electric motor or an electric generator for generating a stream of photons. The fiber optic element is coated with a magnetically reactive material such as mercury or a mercury compound, whereby photons are released when the fiber optic element is placed in the electromagnetic field. The photons may be directed by controlling the cross section of the fiber optic element. A collector may be utilized for collecting the stream of photons for conversion into useable energy.

### BACKGROUND OF THE INVENTION

1. Field of the Invention

The invention is generally related to photon generators and is more specifically directed to a photon generator utilizing an electromagnetic field as the energy source for generating the photons.

2. Discussion of the Prior Art

In physics, a photon is an elementary particle, the quantum of the electromagnetic interaction and the basic “unit” of light and all other forms of electromagnetic radiation. It is also the force carrier for the electromagnetic force. The effects of this force are visible at both the microscopic and macroscopic level, because the photon has no rest mass; this allows for interactions at long distances. Like all elementary particles, photons are governed by quantum mechanics and will exhibit wave-particle duality—they exhibit properties of both waves and particles. For example, a single photon may be refracted by a lens or exhibit wave interference, but also act as a particle giving a definite result when quantitative mass is measured.

Photons are a necessary consequence of physical laws having a certain symmetry at every point in space-time. The intrinsic properties of photons, such as charge, mass and spin, are determined by the properties of this gauge symmetry. This concept has led to numerous advances in experimental and theoretical physics, such as lasers, Bose-Einstein condensation, quantum field theory, and the probabilistic interpretation of quantum mechanics. It has been applied to photochemistry, high-resolution microscopy, and measurements of molecular distances. Recently, photons have been studied as elements of quantum computers and for sophisticated applications in optical communication such as quantum cryptography.

It is known to provide a photon generator having an electron gun for emitting an electron beam, and a laser for emitting a laser beam. The laser beam repetitively collides to produce, by way of example, x-rays. For example, a high energy laser may be used for emitting a laser beam, wherein an evacuated interaction track or ring may be operatively joined to the electron gun and the laser for circulating the electron beam in a closed loop therethrough to repetitively collide with the laser beam for in turn emitting a high energy photon beam from collisions between the electron and laser beams. In this way, high energy photons may be generated or produced by scattering laser light off electrons based on Thomson scattering or Compton scattering.

### SUMMARY OF THE INVENTION

The subject invention is directed to a photon generator that utilizes an electromagnetic field as the energy source for generating the photon. In the preferred embodiment this is accomplished by introducing a fiber optic element into the magnetic field created by a motor or generator or the like. The magnetic field contains sufficient energy to cause the electrons to move from their stationary orbit. This impact with the field causes the photon to be given off before allowing the electron to move back to its orbit. Specifically, a fiber optic element treated with a magnetically reactive element or compound runs parallel to the axis of the motor between the rotor and the stator. Alternatively, the magnetically reactive element or compound may be coated on the motor housing, rather than coating the fiber optic element. A photon stream is generated in the electromagnetic field which surrounds the housing through the fiber optic element. The photon stream may then be collected for providing energy which can then be directed to do work. The fiber optic element can be shielded or not, as long as the element is treated with a “magnetically reactive” element or compound. It can be treated topically or the glass may be “doped” with it during manufacture. The element may also be made from polymer.

The magnetic field normally generated by the rotating motor excites the magnetically reactive material which is in proximity to the fiber optic element, generating the stream of photons. This stream may then be directed to a converter for converting the optical signal into an electrical signal which may be transmitted in the normal manner.

### BRIEF DESCRIPTION OF THE DRAWINGS

FIG. 1 is a flow chart of the circuitry in accordance with the teachings of the subject invention.

FIG. 2 is an illustration of the photon generator as used in connection with the subject invention.

### DESCRIPTION OF THE PREFERRED EMBODIMENT

The subject invention is, in the broadest sense, a transmission system for first converting a source of energy into photons for transmission and then converting it into an electrical signal at a remote location. The source energy is an electromagnetic field which may be provided by a generator or an electric motor or the like. This source of energy is used to excite an optical device such as a fiber optic element and provides a source for the optical photon signal which is then converted into an electrical signal or other useable energy at a remote location.

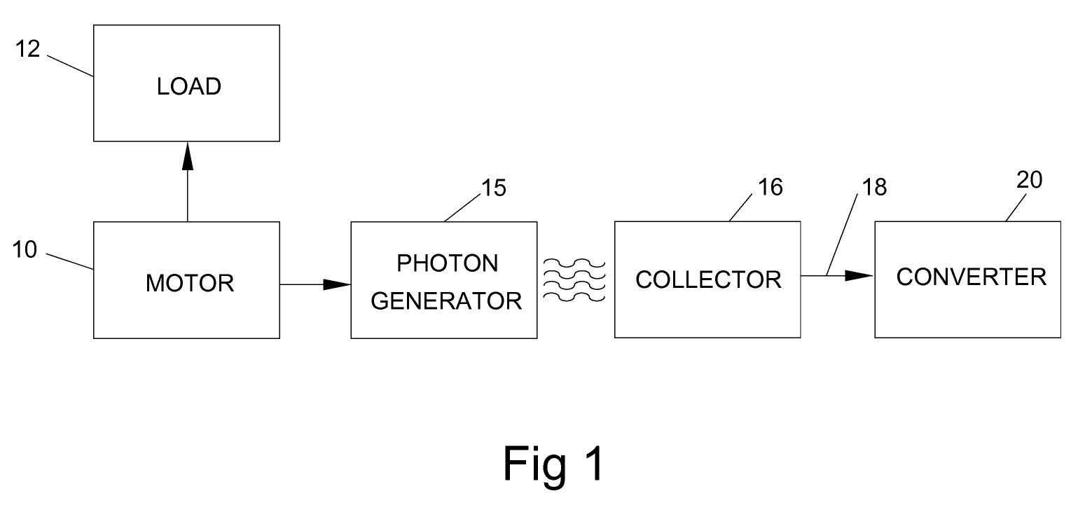

The subject invention works with either a standard AC or DC electric motor or generator and is adapted for generating photons through normal operation of the motor. A flow diagram of the system is shown in FIG. 1. As there shown, an electric motor 10 is connected to a load 12 in the well known manner. The motor derives its power from a standard power source (not shown). The photon generator 15 of the subject invention utilizes the normal magnetic fields of the operating motor.

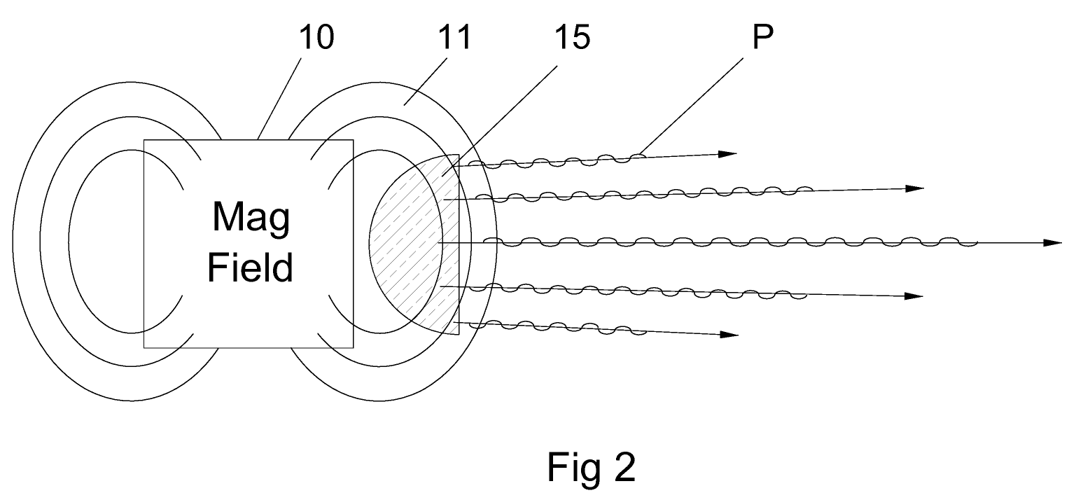

Specifically, and in accordance with the subject invention, a photon generator 15 is created by introducing a fiber optic element into the magnetic field 11 (see FIG. 2) created by the motor 10. The magnetic field contains sufficient energy to cause the electrons to move from their stationary orbit. This impact with the field causes the photons P to be given off before allowing the electron to move back to its orbit. Specifically, a fiber optic element treated with a magnetically reactive element or compound runs parallel to the axis of the motor between the rotor and the stator. Alternatively, the magnetically reactive element or compound may be coated on the motor housing, rather than coating the fiber optic element. A photon stream is generated in the electromagnetic field which surrounds the housing through the fiber optic element. The photon stream may then be collected for providing energy which can then be directed to do work. The fiber optic element can be shielded or not, as long as the element is treated with a “magnetically reactive” element or compound. It can be treated topically or the glass may be “doped” with it during manufacture. The element may also be made from polymer.

With specific reference to FIG. 2, the electric motor 10 generates a magnetic field 11. By placing the doped fiber optic element 15 in the magnetic field, photons P are generated and may be directed to along a controlled path, as illustrated in the present instance by the parabolic cross-section of the element. Photons are generated by the introduction of the fiber optic element (shielded, unshielded, coated, uncoated) into the magnetic field with sufficient energy that the electrons are caused to move from their stationary orbit. This impact with the field causes the photon to be given off before allowing the electron to move back to its orbit.

By way of example, fiber optic element treated with Mercury is positioned relative to the stator of a ½ hp, 115 volt, AC, 3450 RPM motor and upon starting the motor a photon stream is generated which can then be directed to do work. The fiber optic element can be shielded or not, as long as the element or the motor housing is treated with a magnetically reactive element or compound. It can be treated topically or the glass may be doped with it during manufacture. The element may also be made from polymer. The magnetic field doesn't necessarily have to be a rotary field, it just has to have sufficient speed to be able to knock the electrons from orbit, i.e., a transformer with a rapid switching system. The coating can be Mercury or a compound of it such as Mercurochrome, or any other magnetically reactive material. The fiber optic element is either glass or plastic, which is doped with the chosen element or compound. The cast glass or polymer is then place in proximity to the magnetic field causing the generated photons to be expelled from the casting. The element can be of random shape or it can be cast as a defined geometric shape, e.g., parabolic as here shown, which will focus the photons into a directed stream. The photon wavelength is dependent upon the element or compound and the configuration of the element.

The generated photons are released in a directed stream, as controlled by the configuration of the fiber optic element. As shown in FIG. 1 a collector 16 receives the photons, after which the photons may be converted into electrical energy, as indicated at 20.

The subject invention is a novel and useful system for generating and converter system for creating useable energy. While certain embodiments and features of the invention have been described in detail herein it will be understood that the invention includes all enhancements and modifications within the scope and spirit of the following claims.

What is claimed is:

1. A photon generator comprising:
a. an energy source for a magnetic field;
b. a fiber optic element placed in a magnetic field for generating a stream of photons;
c. a magnetically reactive material placed in the magnetic field in proximity to the fiber optic element; and
d. a collector for collecting the stream of photons.

2. The apparatus of claim 1, wherein the magnetic reactive material is a coating on the fiber optic cable.

3. The apparatus of claim 1, wherein the magnetic reactive material is a coating on the source for the magnetic field.

4. The apparatus of claim 1, wherein the energy source is a magnetic field generated by an electric motor.

5. The apparatus of claim 1, wherein the energy source is a magnetic field generated by an electric generator.

6. The apparatus of claim 1, wherein the fiber optic element is of a parabolic cross-section.

7. The apparatus of claim 1, wherein the coating is a magnetically reactive element.

8. The apparatus of claim 7, wherein the magnetically reactive element is mercury.

9. The apparatus of claim 1, wherein the coating is a magnetically reactive compound.

10. The apparatus of claim 10, wherein the magnetically reactive compound is a mercury compound.

11. The apparatus of claim 1, further including a collector for receiving the generated photons.

12. The apparatus of claim 11, further including a converter of transforming the collected photons into useful energy.

13. The apparatus of claim 12, wherein the collected photon energy is converted into electrical energy.
